(19) United States
(12) Patent Application Publication
(10) Pub. No.: US 2016/0376837 A1
(43) Pub. Date: Dec. 29, 2016

(54) CORDLESS BLIND ASSEMBLY

(71) Applicant: CHING FENG HOME FASHIONS CO., LTD., Changhua County (TW)

(72) Inventors: SHENG YING HSU, Changhua County (TW); WEN YING LIANG, Changhua County (TW)

(21) Appl. No.: 15/091,590

(22) Filed: Apr. 6, 2016

(30) Foreign Application Priority Data
Jun. 29, 2015 (TW) 104210408

(51) Int. Cl. E06B 9/262; E06B 9/38

(52) U.S. Cl. CPC E06B 9/262; E06B 9/38; E06B 2009/2622; E06B 2009/2625

(57) ABSTRACT

A cordless blind assembly includes a blind body and an operation member is connected to the lower portion of the blind body. Multiple magnet units are connected to the blind body and each have a base and a magnet which is received in the base. Multiple ribs extend from the base and are sewed to the blind body so that the magnet units are easily connected to the blind body.

### BACKGROUND OF THE INVENTION

1. Fields of the invention

The present invention relates to a cordless blind assembly, and more particularly, to a cordless blind assembly with multiple magnet units sewed thereto.

2. Descriptions of Related Art

The conventional window blinds are equipped with operation ropes which hand downward from the top box, and the users pull the operation ropes to fold or expand the blinds. However, the hanging ropes can easily wrap around kids' neck when kids playing the operation ropes. Therefore, U.S. Pat. No. 7,150,304 discloses a cordless blind structure which includes multiple magnets connected to the blind body so that when the users operate the bar at the bottom of the blind to fold the blind body, the magnets are attracted row by row to fold the blind body in sequence. The blind body is expanded by pulling the bar downward to separate the magnets. No worm gears, pulleys and ropes are needed for the cordless blind structure.

However, the magnets have to be fixed to the blind body and covered by a piece of fabric. Usually, the magnets are fixed to the blind body by way of hot-melting, and the piece of fabric is sewed or adhered to the blind body. The processes for fixing the magnets and the piece of fabric are complicated and time consuming.

Besides, the magnets is usually used on the blind body that is made by fabric, that is to say, if the blind body is made by bamboo, the pieces of fabric cannot easily be attached to the bamboo blind body.

The present invention intends to provide a cordless blind assembly with magnet units which are easily sewed to the blind body.

### SUMMARY OF THE INVENTION

The present invention relates to a cordless blind assembly and comprises a blind body having an operation member connected to the lower portion thereof. Multiple magnet units are connected to the blind body and each have a base and a magnet. The base has a room defined therein and the magnet is received in the room. The base has a closed first side which has a hole defined therethrough. The second side of the base is defined as a connection side which is connected to the blind body. Multiple ribs extend from the base, and the ribs and the connection side are fixed to the blind body.

Preferably, the ribs are sewed to the blind body.

Preferably, the meter of the hole is smaller than the inner diameter of the room.

Preferably, the ribs are in flush with the connection side.

Preferably, the magnet includes a first side and a second side, wherein the first side faces the hole, and the second side faces the connection side.

Preferably, the magnet units are connected to the blind body at even distances.

The advantages of the present invention are that the magnet units are assembled before being connected to the blind body such that the individual parts such as the bases, the magnets and the ribs can be organized properly to increase the efficiency of work.

The magnet units can be connected the blind bodies of different material.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the cordless blind assembly of the present invention;

FIG. 2 is an exploded view of the magnet unit and the blind body of the cordless blind assembly of the present invention;

FIG. 3 is an enlarged view to show that the magnet unit is connected to the blind body of the cordless blind assembly of the present invention;

FIG. 4 shows that the blind body is folded by pushing the operation member upward;

FIG. 5 is an enlarged side view to show the magnet units are attracted to each other, and

FIG. 6 shows that the magnet units are connected to the blind body made of bamboo.

### DETAILED DESCRIPTION OF THE PREFERRED EMBODIMENT

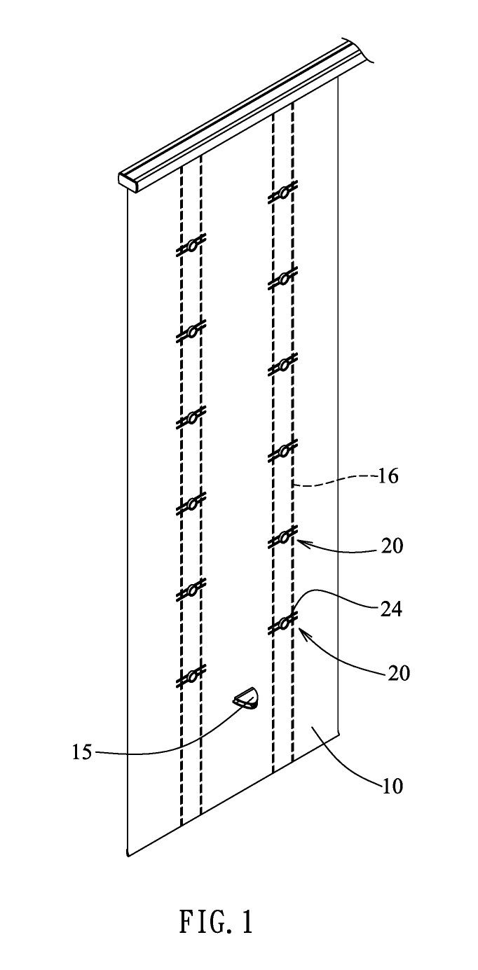

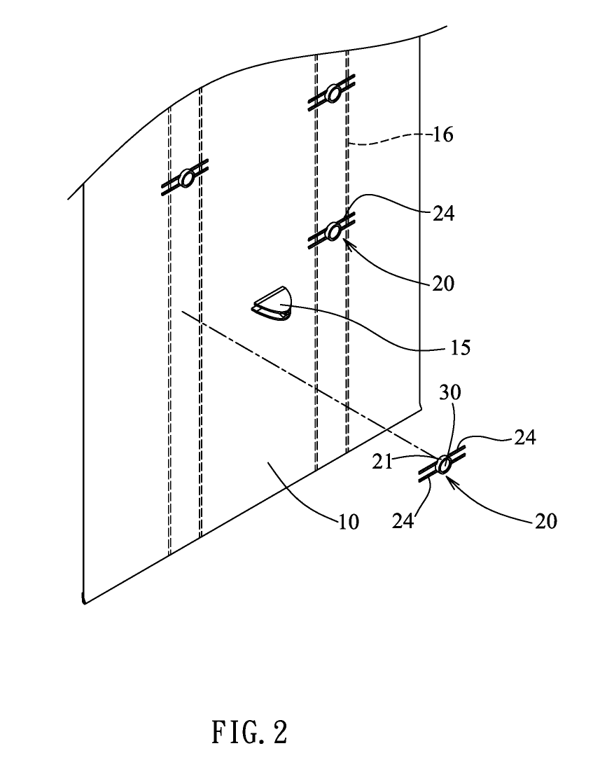

Referring to FIGS. 1 to 2, the cordless blind assembly of the present invention comprises a blind body 10 having multiple magnet units 20 connected to the blind body 10 at even distances. An operation member 15 connected to the lower portion of the blind body 10 so as to expand or fold the blind body 10.

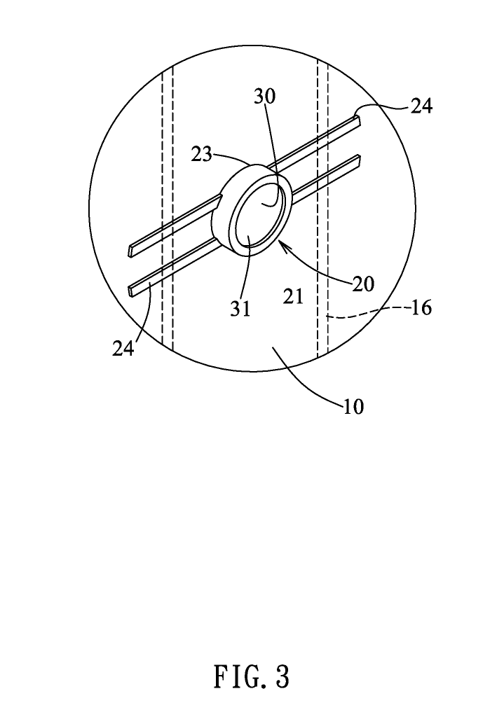

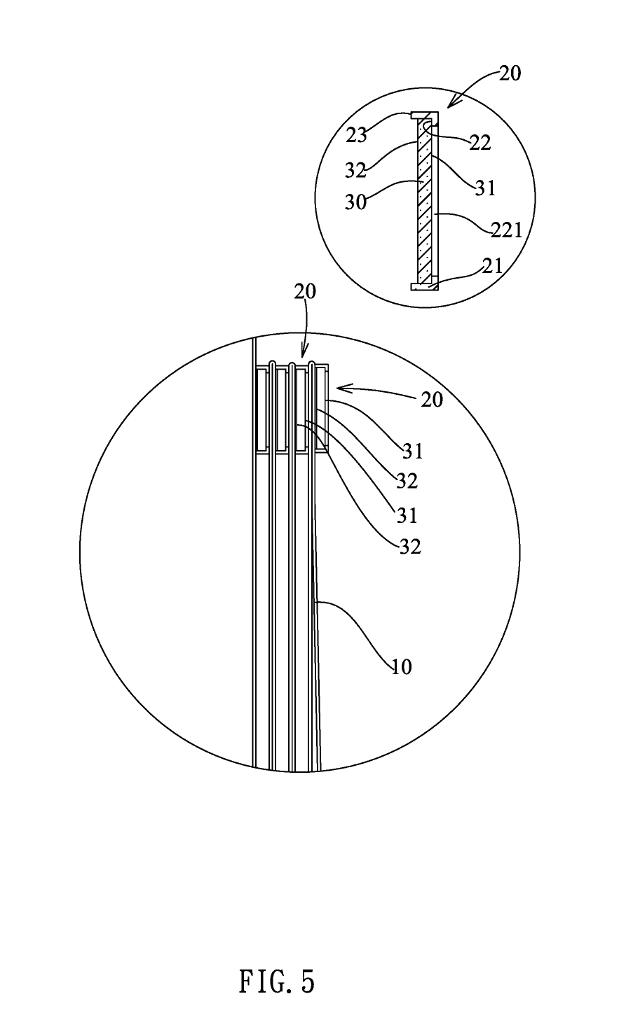

As shown in FIGS. 3 and 5, multiple magnet units 20 are connected to the blind body 10 and each have a base 21 and a magnet 30. The base 21 has a room 22 defined therein and the magnet 30 is received in the room 22. The base 21 has a closed first side which has a hole 221 defined therethrough, wherein the diameter of the hole 221 is smaller than the inner diameter of the room 22. The second side of the base 21 is defined as a connection side 23 which is connected to the blind body 10. Two ribs 24 extend from the base 2 1 at a distance, and the ribs 24 are in flush with the connection side 23. The magnets 30 each include a first side 31 and a second side 32, wherein the first side 31 faces the hole 221, and the second side 32 faces the connection side 23. The magnet units 20 are assembled before being connected to the blind body 10.

As shown in FIGS. 1 to 3, the magnet units 20 are positioned to the blind body 10 by the connection side 23 attached to the blind body 10. The ribs 24 are arranged horizontally and the magnet units 20 are arranged along two rows along the elongate direction of the blind body 10. The ribs 24 are sewed to the blind body 10 by the seam lines 16 as disclosed in the drawings.

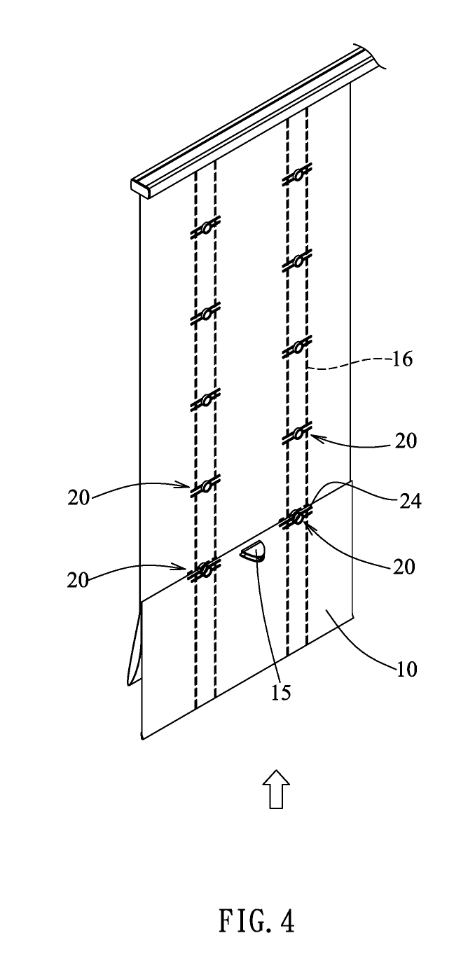

As shown in FIGS. 1, 4 and 5, when folding the blind body 10, the user holds the operation member 15 and lifts the lower end of the blind body 10 upward so that the magnet units 20 at the lowest positions are moved upward and attracted by the next row of the magnet units 20. The second sides 32 of the magnets 30 of the lowest magnet units 20 are attracted by the first sides 31 of the magnets 30 of the next row of the magnet units 20. Therefore, the blind body 10 is folded as shown in FIG. 4. The magnet units 20 can be attracted to the next row of the magnet units 20 in sequence. When expanding the blind body 10, the users simply pull the operation member 15 downward to separate the attracted magnet units 20, the blind body 10 is lowered.

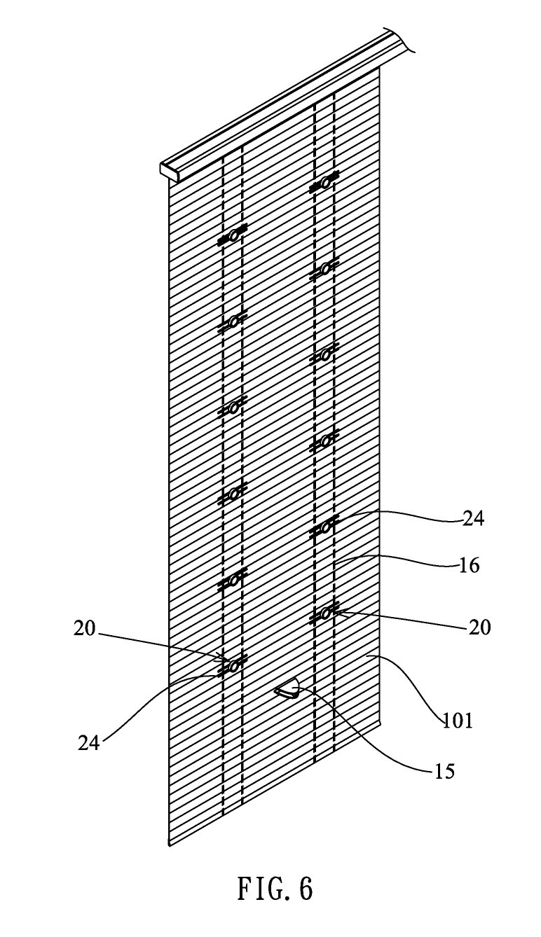

As shown in FIG. 6, when the blind body 101 is made of bamboo, the magnet units 20 can also be sewed to the blind body 101. IN other words, the magnet units 20 can be easily fixed to the blind body 101 of different material.

While we have shown and described the embodiment in accordance with the present invention, it should be clear to those skilled in the art that further embodiments may be made without departing from the scope of the present invention.

What is claimed is:

1. A cordless blind assembly comprising:
a blind body having an operation member connected to a lower portion thereof, and multiple magnet units connected to the blind body and each having a base and a magnet, the base having a room defined therein and the magnet received in the room, the base having a closed first side which has a hole defined therethrough, a second side of the base defined as a connection side which is connected to the blind body, multiple ribs extending from the base, the ribs and the connection side being fixed to the blind body 10.

2. The cordless blind assembly as claimed in claim 1, wherein the ribs are sewed to the blind body.

3. The cordless blind assembly as claimed in claim 1, wherein a diameter of the hole is smaller than an inner diameter of the room.

4. The cordless blind assembly as claimed in claim 1, wherein the ribs are in flush with the connection side.

5. The cordless blind assembly as claimed in claim 1, wherein the magnet includes a first side and a second side, the first side faces the hole, and the second side faces the connection side.

6. The cordless blind assembly as claimed in claim 1, wherein the magnet units are connected to the blind body at even distances.
